(19) United States
(12) Patent Application Publication
(10) Pub. No.: US 2007/0292078 A1
(43) Pub. Date: Dec. 20, 2007

(54) Wavelength division multiplexing optical monitor

(75) Inventor: Takeo Iwama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/544,651

(22) Filed: Oct. 10, 2006

(30) Foreign Application Priority Data
Jun. 20, 2006 (JP) 2006-170175

(51) Int. Cl. G02B 6/28

(52) U.S. Cl. 385/24

(57) ABSTRACT

A wavelength division multiplexing optical monitor has optical fiber connectors disposed at opposite ends thereof, an optical fiber that extends between the optical fiber connectors at the opposite ends and on which a fiber grating is formed that disperses part of the light transmitted in the optical fiber, a ferrule that covers the optical fiber and is optically transparent at least in a part facing the fiber grating, a photodiode array that has an array of multiple photodiodes that receive light of wavelengths dispersed by the fiber grating and transmitted through the ferrule, and a light-emitting diode array that has an array of multiple light-emitting diodes that emit light depending on the intensities of light received at the respective photodiodes.

### BACKGROUND OF THE INVENTION

1. Field of the Invention

The present invention relates to a wavelength division multiplexing optical monitor used for a wavelength multiplexing communication system.

2. Description of the Related Art

The transmission capacity of optical communication systems are being increased by wavelength division multiplexing, which involves simultaneously transmitting multiple channels of light of slightly different wavelengths through one optical fiber. Accordingly, there is a need for an optical monitor for checking which wavelength of light is currently being transmitted.

FIG. 1 is a diagram showing an exemplary conventional wavelength division multiplexing optical monitor.

Light transmitted through an optical fiber 1 is directed to the interior of an optical monitor 10 and first depolarized by a depolarizer 11. The depolarized light is converted into parallel light by a collimator lens 12, and the parallel light is dispersed into light of different wavelengths by a grating 13. The light of different wavelengths is applied onto a photodiode array 17 after passing through a lens 14 and being reflected by a mirror 15. A reception light signal from the photodiode array 17 is transferred to an external host computer or the like (not shown) via a signal processing/interface board 18. A similar monitor is disclosed in Japanese Patent Laid-Open No. 2000-82838.

The optical monitor described above has an advantage that the intensity of light of each wavelength can be measured with high precision. However, the optical monitor has disadvantages in size and cost, and there is a demand for a small and simple optical monitor.

### SUMMARY OF THE INVENTION

The present invention has been made in view of the above circumstances and provides a wavelength division multiplexing optical monitor that is small and simple to use.

A wavelength multiplexing optical monitor according to the present invention has:

optical fiber connectors disposed at opposite ends thereof;

an optical fiber that extends between the optical fiber connectors at the opposite ends and on which a fiber grating is formed that disperses part of the light transmitted in the optical fiber;

a ferrule that covers the optical fiber and is optically transparent at least in a part facing the fiber grating;

a light receiving section that has an array of multiple light receiving elements that receive light of wavelengths dispersed by the fiber grating and transmitted through the ferrule; and

a light emitting section that has an array of multiple light emitting elements that emit light depending on the intensities of light received at the respective light receiving elements.

The wavelength division multiplexing optical monitor according to the present invention is configured so that the fiber grating formed on the optical fiber extracts some of the optical power by dispersion and guides the extracted optical power to the light receiving elements, and the light emitting elements emit light according to light reception signals generated by the light receiving elements. If the optical monitor is connected to the middle of the optical transmission path constituted by an optical fiber, it is possible to easily visually check which wavelength of light is currently being transmitted through the optical transmission path.

In the wavelength division multiplexing optical monitor according to the present invention, it is preferred that the light receiving section has an optical filter that removes high-order diffracted light in the light dispersed by the fiber grating and transmitted through the ferrule before the light is guided to the light receiving elements.

By removing the high-order diffracted light, monitoring can be conducted with higher precision.

In addition, in the wavelength division multiplexing optical monitor according to the present invention, it is preferred that the light receiving section has multiple lenses each of which focuses light of a wavelength dispersed by the fiber grating and transmitted through the ferrule to a light receiving element that is responsible for reception of the light of the wavelength.

With such a configuration, the precision of optical coupling between the grating and the light receiving elements is enhanced, and light of a desired wavelength in the light dispersed by the grating can be transmitted to a desired light receiving element with reliability, so that monitoring can be conducted with higher precision.

According to the present invention described above, there is provided a wavelength division multiplexing optical monitor that is small and-simple to use.

### BRIEF DESCRIPTION OF THE DRAWINGS

FIG. 1 is a diagram showing an exemplary conventional wavelength division multiplexing optical monitor;

FIG. 2 is a schematic diagram showing a wavelength division multiplexing optical monitor according to a first embodiment of the present invention;

FIG. 3 is a conceptual diagram showing a photodiode array;

FIG. 4 is a schematic diagram showing a wavelength division multiplexing optical monitor according to a second embodiment of the present invention;

FIG. 5 is a schematic diagram showing a wavelength division multiplexing optical monitor according to a third embodiment of the present invention; and

FIG. 6 is a diagram for illustrating an exemplary use of a wavelength division multiplexing optical monitor according to an embodiment of the present invention.

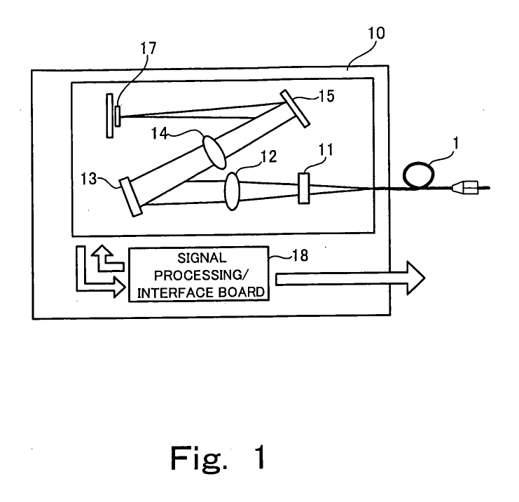

### DETAILED DESCRIPTION OF THE INVENTION

In the following, embodiments of the present invention will be described.

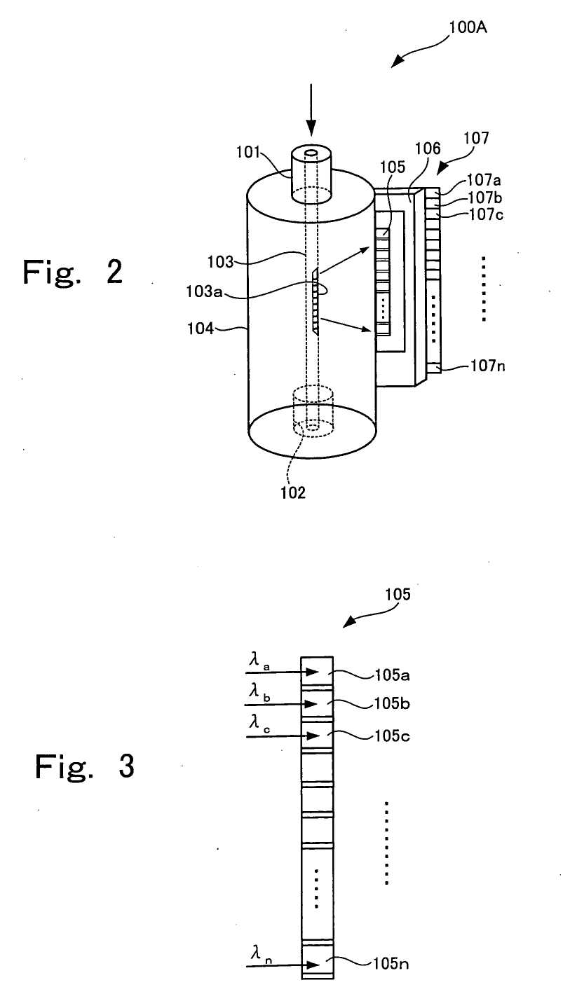

FIG. 2 is a schematic diagram showing a wavelength division multiplexing optical monitor according to a first embodiment of the present invention.

A wavelength division multiplexing optical monitor 100A shown in FIG. 2 has optical fiber connectors 101 and 102 at the opposite ends thereof. Of the two optical fiber connectors 101 and 102, the optical fiber connector 101 is a male connector that is to be coupled to a female connector attached to an end of an optical fiber (referred to as first optical fiber) (not shown), the female connector being of the same type as the other optical fiber connector 102 described below. The other optical fiber connector 102 of the two optical fiber connectors 101 and 102 is a female connector that is to be coupled to a male connector attached to an end of another optical fiber (referred to as second optical fiber) (not shown), the male connector being of the same type as the optical fiber connector 101.

The wavelength division multiplexing optical monitor 100A shown in FIG. 2 has an optical fiber 103 extending between the optical fiber connectors 101 and 102 at the opposite ends and a ferrule 104 made of transparent glass surrounding the optical fiber 103.

Light transmitted through the first optical fiber (not shown) is transmitted through the optical fiber 103 after passing through the female connector attached to the end of the first optical fiber and the optical fiber connector 101 coupled to the female connector. Then, the light is transmitted to the second optical fiber after passing through the female optical fiber connector 102 and the male connector attached to the end of the second optical fiber (not shown) coupled to the optical fiber connector 102.

The optical fiber 103 of the wavelength division multiplexing optical monitor 100A shown in FIG. 2 has a grating 103a formed thereon. Part of the light transmitted through the optical fiber 103 is dispersed by the grating 103a. The light dispersed by the grating 103a is directed to a photodiode array 105 through the optical fiber 103, and multiple photodiodes forming the photodiode array 105 receive light of wavelength bands λₐ, λ_{b}, λ_{c}, . . . , and λₙ, respectively.

FIG. 3 is a conceptual diagram showing the photodiode array.

The photodiode array 105 has an array of multiple photodiodes 105a, 105b, 105c, . . . , and 105n. The photodiodes 105a, 105b, 105c, . . . , and 105n receive light of wavelength bands λₐ, λ_{b}, λ_{c}, . . . and λₙ, respectively, in the light that is dispersed by the grating 103a of the optical fiber 103 and directed to travel from the optical fiber 103 to the photodiode array 105 through the ferrule 104.

Referring back to FIG. 2, the optical monitor will be described again.

The wavelength division multiplexing optical monitor 100A shown in FIG. 2 further has a circuit board 106 and a light-emitting diode array 107 mounted on the circuit board 106.

Light reception signals from the photodiodes 105a, 105b, 105c, . . . , and 105n forming the photodiode array 105 are transmitted to light-emitting diodes 107a, 107b, 107c, and 107n forming the light-emitting diode array 107, respectively, via a circuit on the circuit board 106. In this circuit board 106, according to this embodiment, at each of the photodiodes 105a, 105b, 105c, . . . , and 105n, the level of the light reception signal is compared with a threshold to determine whether or not the amount of the received light is equal to or higher than a predetermined quantity. Any light-emitting diode associated with a light-receiving element for which the level of the light reception signal is equal to or higher than the threshold is supplied with a current at a level enough to turn on the light-emitting diode. If there is any light-emitting diode associated with a light-receiving element for which the level of the light reception signal is lower than the threshold, the current supply to the light-emitting diode is stopped to turn off the light-emitting element. An observer visually checks the light-emitting diode array 107 to determine which wavelength is currently being used for communication or whether a failure or defect occurs on the transmission line.

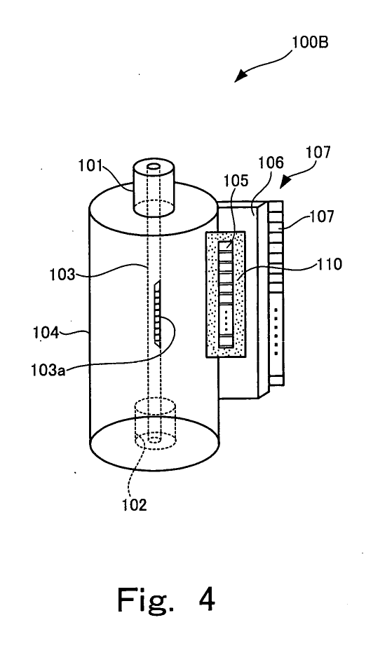

FIG. 4 is a schematic diagram showing a wavelength division multiplexing optical monitor according to a second embodiment of the present invention. A difference from the first embodiment shown in FIG. 2 will be described.

Compared with the wavelength division multiplexing optical monitor 100A shown in FIG. 2, a wavelength division multiplexing optical monitor 100B shown in FIG. 4 further has an optical filer 110.

The optical filter 110 is intended to remove high-order diffracted light in the light that is dispersed by the grating 103a formed on the optical fiber 103 and transmitted through the ferrule 104 before the light is guided to the photodiode array 107. The optical filter 110 allows removal of high-order diffracted light or other light of an unwanted wavelength band, so that light reception can be achieved with higher precision.

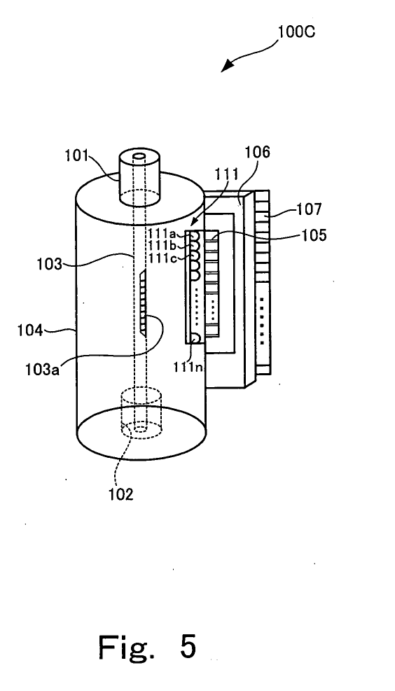

FIG. 5 is a schematic diagram showing a wavelength division multiplexing optical monitor according to a third embodiment of the present invention. Again, a difference from the first embodiment shown in FIG. 2 will be described.

An wavelength division multiplexing optical monitor 100C shown in FIG. 5 has a micro-lens array 111 having an array of multiple micro-lenses 111a, 111b, 111c, . . . , and 111n. For example, in the case where the pitch of light rays of wavelengths λₐ, λ_{b}, λ_{c}, . . . , and λₙ that are dispersed by the grating 103a and travel to the photodiodes 105a, 105b, 105c, . . . , and 105n of the photodiode array 105 (see FIG. 3) does not correspond with the pitch of the photodiodes, the micro-lens array 111 allows the light rays of wavelengths λₐ, λ_{b}, λ_{c}, . . . , and λₙ dispersed by the grating 103a to be guided with reliability to the photodiodes 105a, 105b, 105c, . . . , and 105n of the photodiode array 105, respectively.

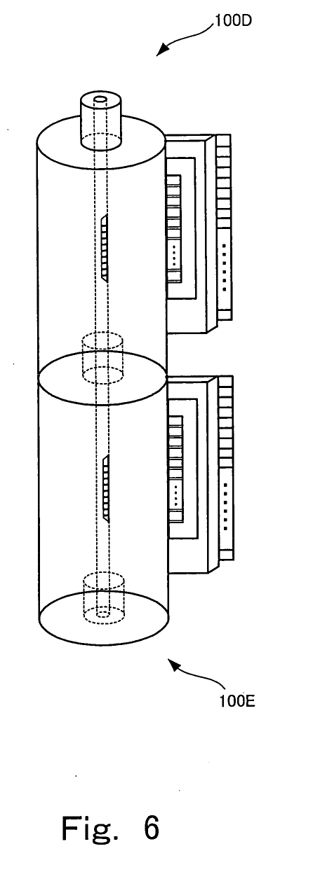

FIG. 6 is a diagram for illustrating an exemplary use of a wavelength division multiplexing optical monitor according to an embodiment of the present invention.

FIG. 6 shows two wavelength division multiplexing optical monitors 100D and 100E whose optical fiber connectors are coupled to each other. The two wavelength division multiplexing monitors 100D and 100E are both of the same type as the wavelength division multiplexing optical monitor 100A shown in FIG. 2 but differ in wavelength band of the light dispersed by the grating and guided to the photodiode array. That is, the wavelength division multiplexing optical monitor 100D is a wavelength division multiplexing optical monitor that monitors light within a wavelength band of about 1530 nm to 1565 nm, which is referred to as C band, by dividing the C band into wavelengths. The other wavelength division multiplexing optical monitor 100E is a wavelength division multiplexing optical monitor that monitors light within a wavelength band of about 1570 nm to 1610 nm, which is referred to as L band, by dividing the L band into wavelengths. The wavelength division multiplexing optical monitor having the structure shown in FIG. 2 (and the wavelength division multiplexing optical monitors shown in FIGS. 4 and 5) is not limited in wavelength band to be monitored. For example, as in the case shown in FIG. 6, separate wavelength division multiplexing optical monitors for monitoring the C wavelength band and the L wavelength band, respectively, may be used. The wavelength division multiplexing optical monitor 100D designed for the C band can be used for monitoring the transmission line of the optical communication using the C wavelength band, and the wavelength division multiplexing optical monitor 100E designed for the L band can be used for monitoring the transmission line of the optical communication using the L wavelength band. For a transmission line of high-volume optical communication using both the C and L wavelength bands, one wavelength division multiplexing optical monitor that monitors light within both the C and L wavelength bands may be used, or two wavelength division multiplexing optical monitors 100D and 100E designed for the C and L bands, respectively, coupled to each other as shown in FIG. 6 may be used.

What is claimed is:

1. A wavelength division multiplexing optical monitor, comprising:
optical fiber connectors disposed at opposite ends thereof;
an optical fiber that extends between the optical fiber connectors at the opposite ends and on which a fiber grating is formed that disperses part of the light transmitted in the optical fiber;
a ferrule that covers the optical fiber and is optically transparent at least in a part facing the fiber grating;
a light receiving section that has an array of a plurality of light receiving elements that receive light of wavelengths dispersed by the fiber grating and transmitted through the ferrule; and
a light emitting section that has an array of a plurality of light emitting elements that emit light depending on the intensities of light received at the respective light receiving elements.

2. The wavelength division multiplexing optical monitor according to claim 1, wherein the light receiving section has an optical filter that removes high-order diffracted light in the light dispersed by the fiber grating and transmitted through the ferrule before the light is guided to the light receiving elements.

3. The wavelength division multiplexing optical monitor according to claim 1, wherein the light receiving section has a plurality of lenses each of which focuses light of a wavelength dispersed by the fiber grating and transmitted through the ferrule to a light receiving element that is responsible for reception of the light of the wavelength.
